(19) United States
(12) Patent Application Publication
(10) Pub. No.: US 2006/0071050 A1
(43) Pub. Date: Apr. 6, 2006

(54) Multi-head tab bonding tool

(76) Inventor: Steven F. Reiber, Rocklin, CA (US)

Correspondence Address: CARR & FERRELL LLP, 2200 GENG ROAD, PALO ALTO, CA, 94303, US

(21) Appl. No.: 11/227,982

(22) Filed: Sep. 14, 2005

Related U.S. Application Data
(63) Continuation-in-part of application No. 11/107,308, filed on Apr. 15, 2005.
Application No. 11/107,308 is a continuation-in-part of application No. 10/942,311, filed on Sep. 15, 2004.
Application No. 11/107,308 is a continuation-in-part of application No. 10/943,151, filed on Sep. 15, 2004.
Application No. 10/943,151 is a continuation-in-part of application No. 10/650,169, filed on Aug. 27, 2003, now Pat. No. 6,935,548.
Application No. 10/650,169 is a continuation of application No. 10/036,579, filed on Dec. 31, 2001, now Pat. No. 6,651,864.
Application No. 10/650,169 is a continuation-in-part of application No. 09/514,454, filed on Feb. 25, 2000, now Pat. No. 6,354,479.
Application No. 10/650,169 is a continuation-in-part of application No. 10/650,169, filed on Aug. 27, 2003, now Pat. No. 6,935,548.
(60) Provisional application No. 60/610,847, filed on Sep. 17, 2004.
(60) Provisional application No. 60/288,203, filed on May 1, 2001.
(60) Provisional application No. 60/121,694, filed on Feb. 25, 1999.
(60) Provisional application No. 60/503,267, filed on Sep. 15, 2003.

(51) Int. Cl. B23K 37/00

(52) U.S. Cl. 228/4.5

(57) ABSTRACT

A bonding tool for use in multi-head tape automated bonding (TAB) is provided. The bonding tool comprises a plurality of TAB bonding heads, the TAB bonding heads providing for electrical dissipation wherein current flow is low enough so as not to damage a device being bonded and high enough to avoid the build up of a charge that may discharge to the device being bonded.

### CROSS-REFERENCE TO RELATED APPLICATIONS

The present application claims the priority benefit of U.S. provisional patent application No. 60/610,847 (2834PRV) filed Sep. 17, 2004 and entitled “Multi-Head TAB Bonding Tool”; the present application is also a continuation-in-part and claims the priority benefit of U.S. patent application Ser. No. 11/107,308 (3100US) filed Apr. 15, 2005 and entitled “Flip Chip Bonding Tool and Ball Placement Capillary”; U.S. patent application Ser. No. 11/107,308 (3100US) is a continuation-in-part and claims the priority benefit of U.S. patent application Ser. No. 10/942,311 (2617US) filed Sep. 15, 2004 and entitled “Flip Chip Bonding Tool Tip”; U.S. patent application Ser. No. 11/107,308 (3100US) is also a continuation-in-part and claims the priority benefit of U.S. patent application Ser. No. 10/943,151 (2835US) filed Sep. 15, 2004 and entitled “Bonding Tool with Resistance”; U.S. patent application Ser. Nos. 10/942,311 (2617US) and 10/943,151 (2835US) are both continuations-in-part and claim the priority benefit of U.S. patent application Ser. No. 10/650,169 (2615US) filed Aug. 27, 2003 entitled “Dissipative Ceramic Bonding Tool Tip” which is a continuation of and claims the priority benefit of U.S. patent application Ser. No. 10/036,579 (1665US) filed Dec. 31, 2001, now U.S. Pat. No. 6,651,864, entitled “Dissipative Ceramic Bonding Tool Tip,” which claims the priority benefit of U.S. provisional patent application No. 60/288,203 (1665PRV) filed May 1, 2001; U.S. patent application Ser. No. 10/036,579 (1665US) is a continuation-in-part and claims the priority benefit of U.S. patent application Ser. No. 09/514,454 (1118US) filed Feb. 25, 2000, now U.S. Pat. No. 6,354,479 and entitled “Dissipative Ceramic Bonding Tool Tip,” which claims the priority benefit of provisional patent application No. 60/121,694 (1118PRV) filed Feb. 25, 1999; U.S. patent application Ser. No. 10/942,311 (2617US) also claims the priority benefit of U.S. provisional patent application No. 60/503,267 (2617PRV) filed Sep. 15, 2003 and entitled “Bonding Tool.” The disclosure of all of these applications are incorporated herein by reference.

### BACKGROUND OF THE INVENTION

1. Field of the Invention

This invention related to bonding tool tips and, more particularly, to multi-heading bonding tips for bonding electrical flex connections.

2. Description of the Prior Art

Tape Automated Bonding (TAB) is the process of mounting a die on a flexible tape made of polymer material such as polymide. The mounting is done such that the bonding sites of the die, usually in the form of bumps or balls made of gold or solder, are connected to fine conductors on the tape, which provide the means of connecting the die to the package or directly to external circuits. In some instances, the tape of which the die is bonded contains the actual application circuit of the die.

The tape used in the bonding is usually single-sided although two-metal tapes are also available. Copper is a commonly-used metal in these tapes and may be electrodeposited on the tape or attached using adhesive. Metal patterns of a circuit are imaged onto the tape using photolithography methodologies.

The TAB bonds connecting the die and the tape are known as inner lead bonds (ILB), while those that connect the tape to the package or to external circuits are known as outer lead bonds (OLB).

To facilitate the connection of die bumps or balls to their corresponding leads on a TAB circuit, holes are punched on the tape where the die bumps will be positioned. The conductor traces of the tape are then cantilevered over the punched holes to meet the bumps of the die.

There are two common methods of achieving a bond between the gold bump of the die and the lead of a TAB circuit: 1) single-point thermosonic bonding and 2) gang or thermo-compression bonding.

Single-point bonding connects each of the die's bond site individually to its corresponding lead on the tape. Heat, time, force, and ultrasonic energy are applied to the TAB lead, which is positioned directly over the gold bump, forming intermetallic connections between them in the process. Single-point bonding is a more time-consuming process than gang bonding.

Gang bonding employs a specially designed bonding tool to apply force, temperature, and time to create diffusion bonds between the leads and bumps, all at the same time. Without the use of ultrasonic energy, this type of bonding is simply referred to as ‘thermo-compression’ bonding. Gang bonding offers a high throughput rate, and is therefore preferred to single-point bonding.

When a bonding tip is over a flex circuit, a bonding tool will make intimate contact with tabs in a window formed in the flex. These TABs will be over flex circuit bond pads on an amplifier. The bond tool ultrasonically ‘flows’ the TABs onto the bonding pads of the amplifier where molecular bonds produce a reliable electrical and mechanical connection.

FIG. 1A illustrates a plan view of TAB bonding as is known in the art. In FIG. 1A, a polyimide film 110 comprising a series of dual sprockets is provided. The film 110 is moved to a target location and the leads are cut (cut line 120) and soldered to a printed circuit board. ILB 130 go to an IC chip 150 while OLB 140 go to the circuit board. FIG. 1B illustrates a side view of the IC chip and ILB 130 and OLB 140. FIG. 1C illustrates the IC chip 150 adhered and bonded to the PCB and subsequently coated with an insulative epoxy 160.

TAB bonding is increasingly used in a disk drive for assembly of the Head Stack Assembly (HAS) to the Head Gimbal Assembly (HGA). TAB bonding is used for making electrical connections between a head and an amplifier. The most common TAB tool has been a waffle that was developed for Read Rite Corporation in 1999 by Steve Reiber and Gary Pruet. An example of a waffle tool is shown in FIG. 2.

TAB bonding offers certain advantages with regard to the use of smaller bond pads and finer bond pitching; the use of bond pads over all of the die instead of the die periphery thereby increasing possible I/O count; reducing the amount of gold required for bonding; shortening production cycle tirme; reducing noise and increasing frequency; providing for circuit flexibility; and facilitating multi-chip module manufacturing.

To fully enjoy the advantages of TAB bonding requires the use of bonding tools with multiple-heads to allow for acceleration of the bonding process. In order for an operator to utilize a multi-head bond mechanism requires increased durability and increased hardness to avoid the need for regular replacement and/or deformation of the bond head. Prior art bonding tool tips, including those made of aluminum oxide or tungsten carbide—lack the sufficient hardness to prevent deformation under pressure and mechanical durability so that many bonds can be made before replacement.

There is, therefore, a need in the art for a multi-head TAB bonding tool that is of sufficient durability and hardness as to avoid the need for constant replacement or deformation from repeated use. There is a further need in the art for a multi-head TAB bonding tool that satisfies these durability and hardness demands while still offering a reliable electrical contact while preventing electrostatic discharge (ESD) that may damaged an electrical component being bonded.

### SUMMARY OF THE INVENTION

The present invention advantageously provides for the use of multi-head TAB bonding tools to accelerate the TAB bonding process whereby an operator may complete an assembly process through the use of one or two bonds instead of the usual four.

The present invention advantageously provides for an exemplary multi-head TAB bonding tool made from a uniform extrinsic material that has hardness and flexural strength to be utilized in accelerated TAB bonding; silicon carbide, for example.

The present invention also provides for an exemplary multi-head TAB bonding tool formed by a thin layer of a highly doped semiconductor on an insulating core or, alternatively, a lightly doped semiconductor layer on a conducting core.

### BRIEF DESCRIPTION OF THE DRAWINGS

FIG. 1A illustrates a plan view of TAB bonding as is known in the art.

FIG. 1B illustrates a side view of the TAB bonding as described in FIG. 1B.

FIG. 1C illustrates an IC chip bonding to a PCB using a TAB methodology, the IC chip subsequently covered with an insulative epoxy.

FIG. 2 is an exemplary waffle tool for use in TAB bonding as is known in the art.

FIG. 3 illustrates an exemplary single point TAB tool utilizing a double cross groove and as may be utilized in a multi-head TAB bonding tool.

FIG. 4 is an exemplary method for manufacturing a TAB bonding tool head for use in a multi-head TAB bonding tool through the use of mixing, molding, and sintering reactive powders.

FIG. 5 is an exemplary method for manufacturing a TAB bonding tool head for use in a multi-head TAB bonding tool through the use of hot pressing reactive powders.

FIG. 6 is an exemplary method for manufacturing a TAB bonding tool head for use in a multi-head TAB bonding tool through the use of fusion casting.

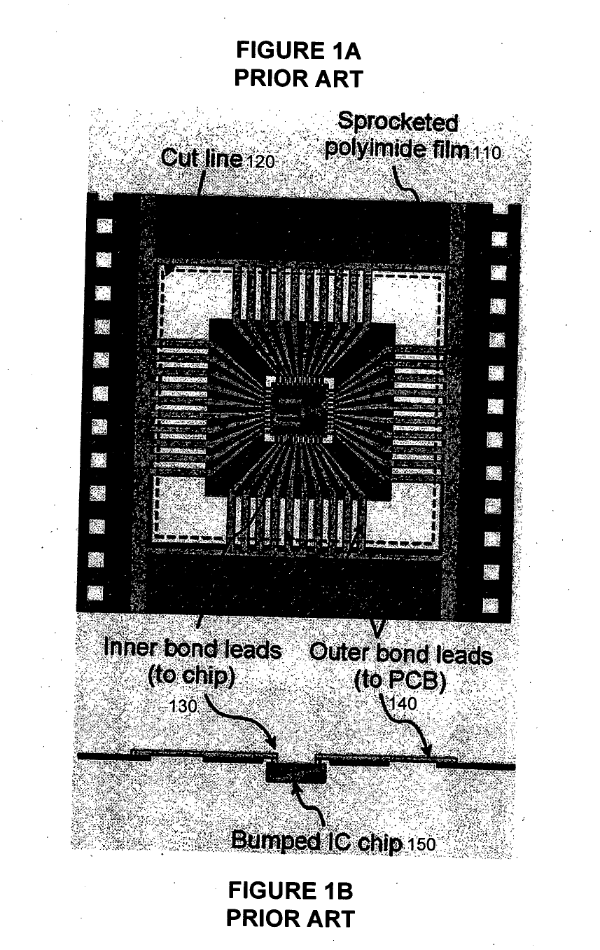

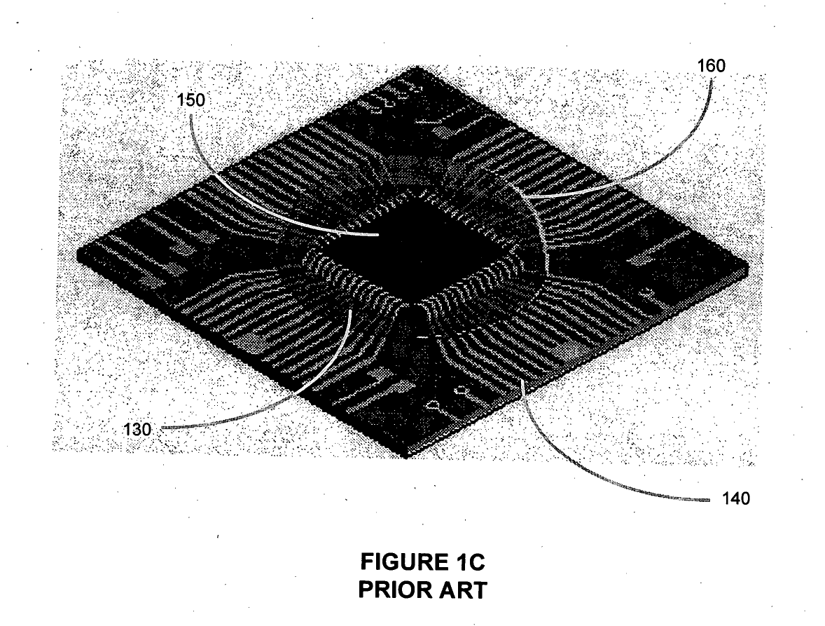

### DETAILED DESCRIPTION OF AN EMBODIMENT

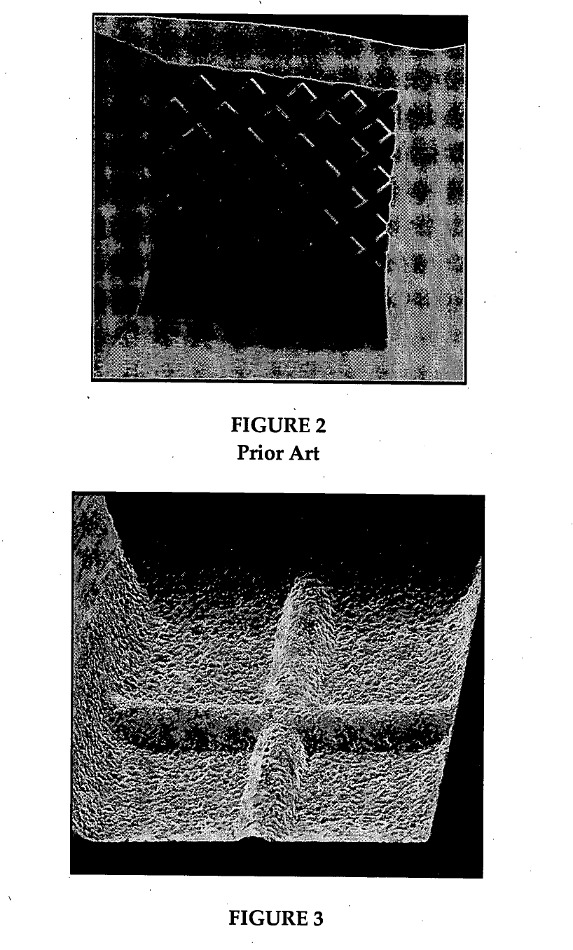

FIG. 3 illustrates a single point TAB tool utilizing a double cross groove according to an embodiment of the present invention and as may be utilized in a multi-head TAB bonding tool. Reference to a double cross groove is not meant to limit the scope of the present TAB tool in that other groove configurations may be utilized. These configurations include, but are not limiting to, a single cross groove, a single point, a protruding ‘V,’ and the aforementioned waffle tool.

An exemplary TAB tool as illustrated in FIG. 3 may be one-half inch (12-13 mm) long and approximately one-sixteenth inch (1.6 mm) in diameter. The bonding tool tip itself is usually a 3 to 10 mils (0.08 to 0.25 mm) square. A two-headed bonding tool may exhibit similar characteristics in that an exemplary two-headed bonding tool may be approximately one-half inch (12-13 mm) long and about one-sixteenth inch (1.6 mm) in diameter. The bonding tool tips may be from 3 to 10 mils (0.08 to 0.25 mm) by 20 to 26 mils. Alternate embodiments may comprise other dimensions.

The bonding tool is configured to cut, guide, shape, and bond the leads to the bond pads of an IC chip in orthogonal and radial directions. The length and width of the tool are ultimately determined by the need for the tool to bring leads from a top surface across a thickness of an elastomer to bonding leads or bond pads. In addition, the occurrence of heel cracks often caused by poor design and finishing must be minimized to prevent pre-matured failures.

The high stiffness and high abrasion resistance requirements of the present invention are, in one embodiment, suited for ceramics (e.g., electrical non-conductors) or metals, such as tungsten carbide (e.g., electrical conductors). The bonding tip should have a Rockwell hardness of approximately 85 or above and should be able to last for at least 15,000 bonding cycles.

Tools may be made from a uniform extrinsic semi-conducting material, which has dopant atoms in appropriate concentration and valence states to produce sufficient mobile charge carrier densities that will result in electrical conduction in a desired range. Polycrystalline silicon carbide uniformly doped with boron is an example of such a uniform extrinsic semi-conducting material.

Tools may be made by forming a thin layer of a highly doped semiconductor on an insulating core. In this configuration, the core provides mechanical stiffness. The semiconductor surface layer provides abrasion resistance and a charge carrier path from tip to mount that will permit dissipation of electrostatic charge at an acceptable rate. A diamond tip wedge that is ion implanted with boron is an example of such a thin layered tool.

Tools may also be made by forming a lightly doped semi-conductor layer on a conducting core. The conducting core provides mechanical stiffness while the semi-conductor layer provides abrasion resistance. and a charge carrier path from tip to conducting core, which is electrically connected to a mount. A doping level is chosen to produce conductivity through the layer which will permit dissipation of electrostatic charge at an acceptable rate. A cobalt-bonded tungsten carbide coated with titanium nitride carbide is an example of such a lightly doped tool.

To avoid damaging delicate electronic devices by an electrostatic discharge, the bonding tool must conduct electricity at a rate sufficient to prevent charge buildup and to dissipate the charge in the device, if any, but not at so high a rate as to overload a device being bonded.

It has been determined that as voltages become lower during the manufacturing process, the resistance range can become lower too. The resistance should be low enough such that material can dissipate small voltages very quickly yet keep the current below 5 milliamps. The resistance should also be high enough so that if it is not a conductor, a transient current can flow through the tool to the device.

In an exemplary embodiment, resistance in the tool assembly should range from 500 to 99,000 ohms of resistance. For example, for today's magnetic recording heads, 5 milliamps of current will result in damage. As such, it is preferred that no more than 2 to 3 milliamps of current be allowed to pass through the tip of the bonding tool to the recording head.

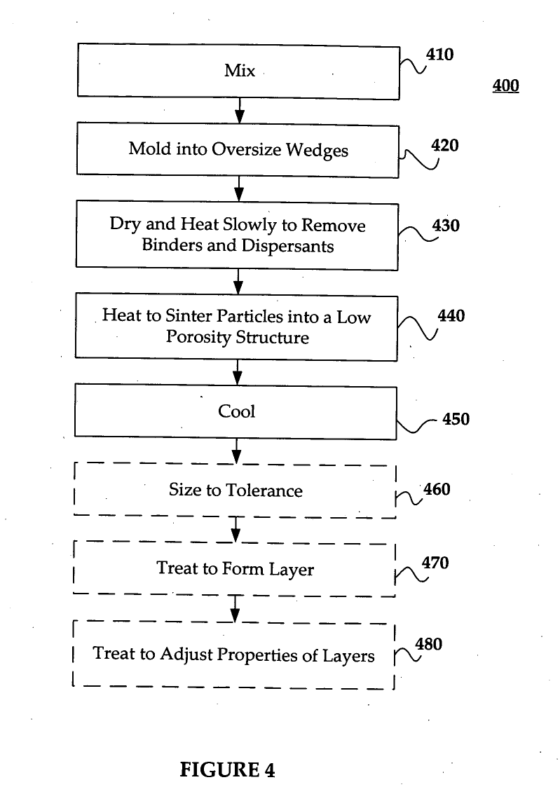

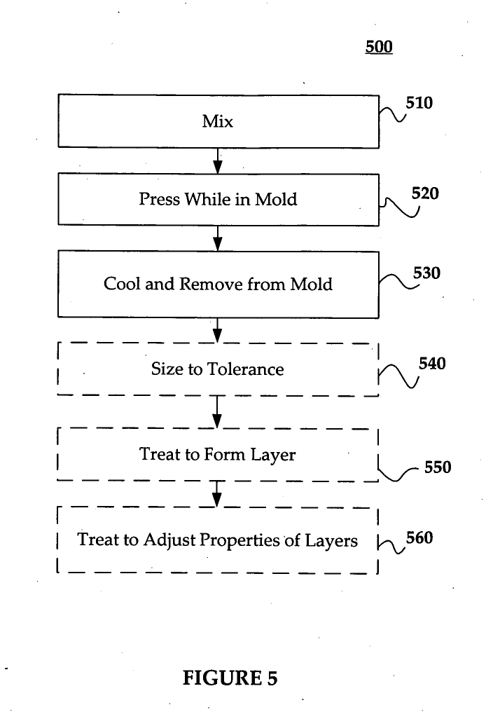

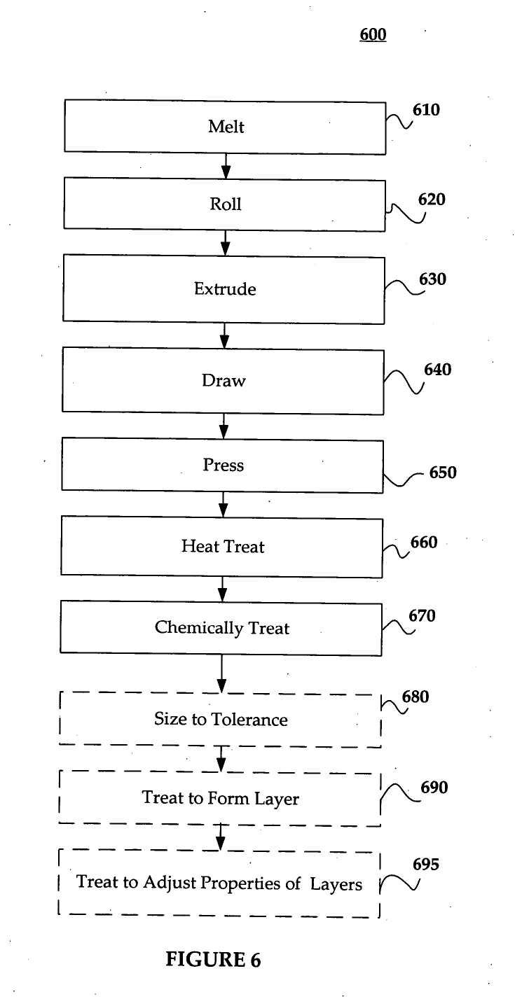

Multi-head TAB bonding tools may be manufactured through the use of a method comprising the mixing, molding, and sintering of reactive powders as shown in FIG. 4. A method comprising the use of hot pressing reactive powders is shown in FIG. 5. A method comprising the use of fusion casting is shown in FIG. 6.

Referring now to FIG. 4, an exemplary flowchart 400 for manufacturing a multi-head TAB bonding tool with certain ESD properties as described. Through the use of mixing, molding, and sintering reactive powders—for example, alumina (Al2O3), zirconia (Zr2O3), iron oxide (FeO2), or titanium oxide (Ti2O3)—fine particles (e.g., a half of a micron in size) of a desired composition are mixed 410 with organic and inorganic solvents, dispersants, binders, and sintering aids. The binder and/or the sintering aids can be any of, any combination of, or all of magnesia, yttria, boron, carbon colloidal silica, alumina solvents, ethyl silicate, any phosphate, any rare earth metal oxide, or yttrium. Solvents, too, can be any of the aforementioned elements, compounds, or combination in addition to H2O, for example.

The mixture is then molded 420 into oversized wedges. The wedges are carefully dried and slowly heated 430 to remove the binders and dispersants. In one embodiment, the wedges are heated to a temperature between 500-2500 degrees Celsius.

The wedges are then heated to a high enough temperature so that individual particles sinter together 440 into a solid structure with low porosity. In one embodiment, the wedges are heated to at least a temperature of 4000 degrees Celsius. The heat-treating atmosphere is chosen to facilitate removal of the binder at a low temperature and to control valence of the dopant atoms at the higher temperature and while cooling 450. After cooling 450, the wedges may be machined 460 to achieve required tolerances.

The wedges may then be treated 470 to produce a desired surface layer (e.g., 100 to 1000 angstroms thick) by ion implementation, vapor deposition, chemical vapor deposition, physical deposition, electroplating deposition, neutron bombardment, or combinations of the above. The pieces may be subsequently heat treated 480 in a controlled atmosphere (e.g., 2000 to 2500 degrees Celsius for 3 to 5 minutes) to produce desired layer properties through diffusion, re-crystallization, dopant activation, or valence changes of metallic ions.

Referring now to FIG. 5, an exemplary flowchart 500 for manufacturing multi-head TAB bonding tools with certain ESD properties as described is shown. Through the use of hot pressing reactive powders—like those disclosed above—fine particles of a desired composition are mixed 510 with binders and sintering aids, like those disclosed above. The mixture is then pressed 520 in a mold at a high enough temperature (e.g., 1000 to 4000 degrees Celsius) to cause consolidation and binding of the individual particles into a solid structure with low porosity (e.g., having grain size of less than half a micron in size). In one embodiment, the temperature is between 1000 and 2500 degrees Celsius. The hot pressing atmosphere is chosen to control the valence of the dopant atoms.

After cooling and removal 530 from the hot press, the pieces may be machined 540 to achieve required tolerances. The pieces may then be treated 550 to produce a desired surface layer by ion implementation, vapor deposition, chemical vapor deposition, physical deposition, electo-plating deposition, neutron bombardment, or combinations of the above.

The pieces may subsequently be heat treated 560 in a controlled atmosphere to produce desired layer properties through diffusion, re-crystallization, dopant activation, or valence changes of metallic ions.

Referring now to FIG. 6, an exemplary flowchart 600 for manufacturing bonding tools with tip resistance using fusion casting is shown. Through fusion casting, metals of a desired composition are melted 610 in a non-reactive crucible before being cast into an ingot. The ingot is then rolled 620, extruded 630, drawn 640, pressed 650, heat-treated 660 (e.g., at 1000 degrees Celsius or 500 degrees Celsius to 2500 degrees Celsius for one to two hours) in a suitable atmosphere, and chemically treated 660.

The rolling 620, extruding 630, drawing 640, and pressing 650 steps shape the tip, while heat treatment 660 and chemical treatment 670 steps affect or impart mechanical and electrical properties such as hardness and resistivity.

The pieces may then be machined 680 to achieve required tolerances. The metallic pieces may also be treated to produce a desired surface layer 690 by vapor deposition, chemical vapor deposition, physical deposition, electroplating deposition, or combinations of the above.

The pieces may subsequently be heat-treated (e.g., 4000 degrees Celsius for three to four hours) in a controlled atmosphere to produce desired layer properties 695 through diffusion, re-crystallization, dopant activation, or valence changes of metallic ions.

The present invention further provides that the layer used in the bonding process may be the following composition of matter; for example, a formula for dissipated ceramic comprising alumina (aluminum oxide Al2O3) and zirconia (zirconium oxide ZrO2) and other elements. This mixture is both somewhat electrically conductive and mechanically durable. The multi-head TAB bonding tool head will be coated with this material or it can be made completely out of this material. The shape of the head may be as shown and described in earlier FIG. 3.

The TAB bonding tool of the present invention may be used for any number of different types of bonding; for example, ultrasonic and thermal flip chip bonding.

While the present invention has been described with reference to exemplary embodiments, it will be understood by those skilled in the art that various changes may be made and equivalents may be substituted for elements thereof without departing from the true spirit and scope of the present invention. In addition, modifications may be made without departing from the essential teachings of the present invention.

What is claimed is:

1. A bonding tool for use in tape automated bonding (TAB), the bonding tool comprising a plurality of TAB bonding heads, the TAB bonding heads providing for electrical dissipation whereby an essentially smooth current dissipates to a device being bonded, the current low enough so as not to damage the device and high enough to avoid the build up of a charge that may discharge to the device.
